(19) United States
(12) Patent Application Publication
(10) Pub. No.: US 2006/0240684 A1
(43) Pub. Date: Oct. 26, 2006

(54) Soldering method & its applied circuit board

(75) Inventor: Wen-Chang Chang, Keelung City (TW)

Correspondence Address: TROXELL LAW OFFICE PLLC;SUITE 1404, 5205 LEESBURG PIKE, FALLS CHURCH, VA, 22041, US

(73) Assignee: Lotes Co., Ltd.

(21) Appl. No.: 11/377,301

(22) Filed: Mar. 17, 2006

(30) Foreign Application Priority Data
Apr. 22, 2005 (CN) 200510034308.9

(51) Int. Cl. H01R 12/00

(52) U.S. Cl. 439/59

(57) ABSTRACT

A method to solder two electronic devices to each other to maintain good electricity conduction between both devices; one device being disposed with multiple pin-shaped soldering ends, another device being disposed with multiple soldering holes, and solder in relation to each hole; the soldering end being inserted into the hole and soldered by heating to melt the solder; and a circuit board disposed with multiple holes with each containing a soldering portion and solder in relation to each hole.

### BACKGROUND OF THE INVENTION

(a) Field of the Invention

The present invention is related to soldering method and its applied circuit board.

(b) Description of the Prior Art

As illustrated in FIGS. 8 and 9 of the accompanying drawings of the present invention, tin paste usually is directly placed on conductor sheet disposed on a circuit board in the course of soldering electricity connector to the circuit board. The melt tin paste connects the conductor terminals from the electricity connector and the conductor sheet to realize its electric connection. However, the electricity connector may be curved and deformed in the course of heating to result in bias of the location of the electricity connector in relation to that of the circuit board. The bias causes to create a void between conductor terminals and the conductor sheet, thus to fail soldering the conductor terminals to the conductor sheet. The failure further affects normal conduction between the circuit board and the electricity connector. Therefore, it warrants a new type of electricity connector to correct the flaws of the prior art as described above.

### SUMMARY OF THE INVENTION

The primary purpose of the present invention is to provide a soldering method that firmly connects two electronic devices, and a circuit board applying the soldering method.

To achieve the purpose, multiple pin-shaped soldering ends are disposed on one electronic device, multiple soldering holes each containing a soldering portion are disposed on the other electronic device, and a solder prepared in relation to each of those holes; so that each pin-shaped soldering end is inserted into its corresponding hole to be heated and soldered to the soldering portions through the solder.

The circuit board of the present invention relates to one that is disposed with multiple soldering holes each containing a soldering portion and solder disposed in relation to each hole.

Compared with the prior art, the present invention is capable of firmly connecting two electronic devices to warrant good electricity conduction between both electronic devices.

### BRIEF DESCRIPTION OF THE DRAWINGS

FIG. 1 is an exploded view showing an electricity connector and a circuit board of the present invention.

FIG. 2 is a perspective view showing an assembly of the electricity connector and the circuit board of the present invention.

FIG. 3 is a sectional view showing a status of the electricity and the circuit board of the present invention before being soldered to each other.

FIG. 4 is a sectional view showing a status of the electricity and the circuit board of the present invention after having soldered to each other.

FIG. 5 is a schematic view showing a status of a second preferred embodiment of the present invention before being soldered to each other.

FIG. 6 is a schematic view showing a status of a third preferred embodiment of the present invention before being soldered to each other.

FIG. 7 is a schematic view showing a status of a fourth preferred embodiment of the present invention before being soldered to each other.

FIG. 8 is a perspective view showing a circuit board of the prior art.

FIG. 9 is a sectional view showing a status of an electricity connector and a circuit board of the prior art before being soldered to each other.

### DETAILED DESCRIPTION OF THE PREFERRED EMBODIMENTS

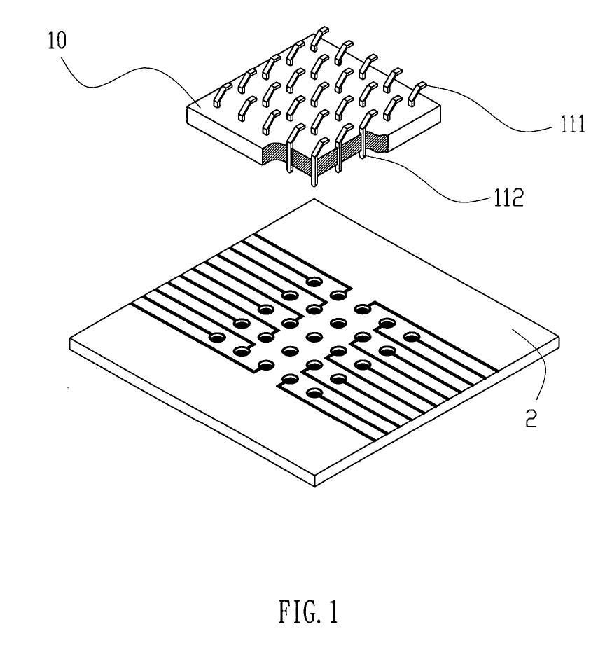

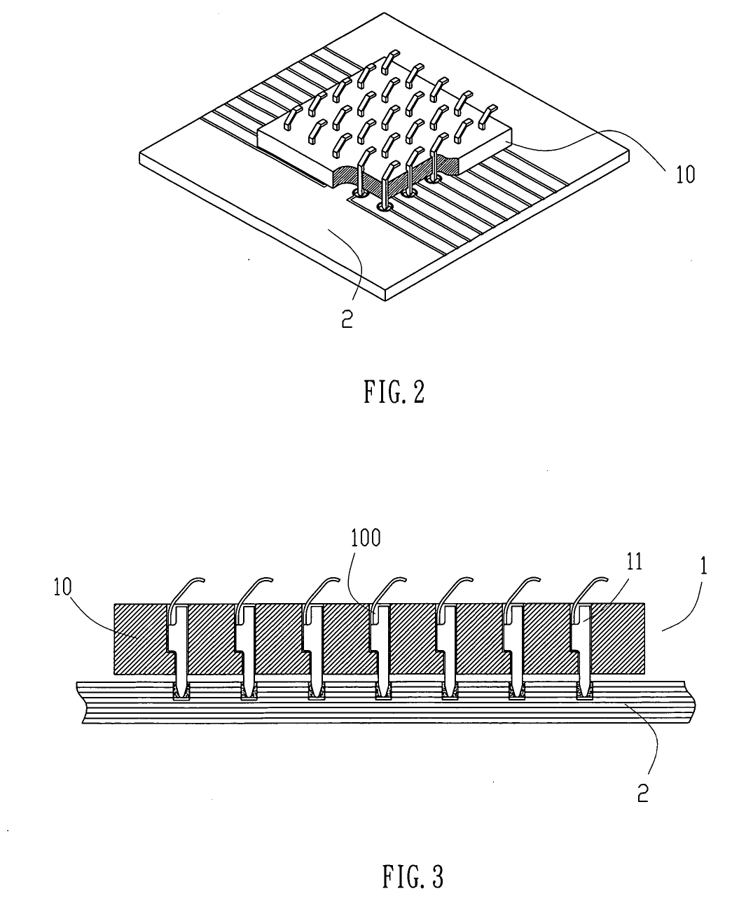

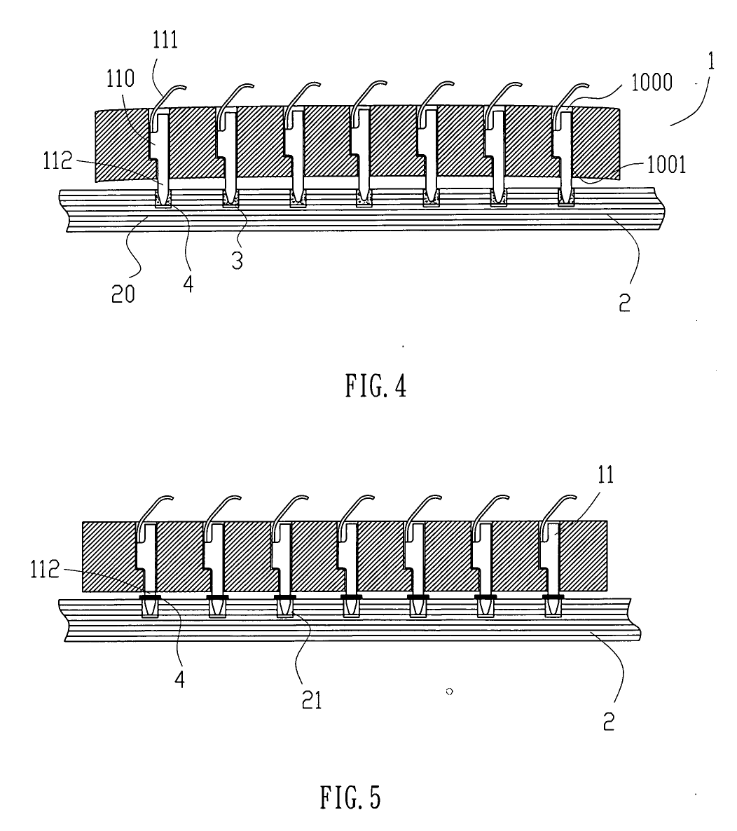

Referring to FIGS. 1 through 4, a soldering method of the present invention is applied to connect two electronic devices to each other. Wherein, both electronic devices may be separately related to a chip, circuit board, or any other type of electronic device. Detailed description herein is only given to how to solder an electricity connector to a circuit board dedicated designed for applying the soldering method of the present invention.

Wherein, the electricity connector 1 includes an insulation body 10 and multiple pin-shaped soldering ends i.e., multiple conductor terminals 11 related in the present invention. Multiple holes 100 are disposed to the insulation body 10 to receive their corresponding conductor terminals 11. Each conductor terminal 11 contains a retaining portion 110, a contact portion 111 extending upward from the retaining portion 110, and a pin-shaped soldering portion 112 extending downward from the retaining portion 110. The hole 100 includes a locking portion 1000 and an insertion portion 1001 penetrating downward from the locking portion 1000 with the locking portion 1000 in a size greater than that of the insertion portion 1001. The soldering portion 112 of each conductor terminal 11 passes through the insertion portion 1001 and is exposed out of the bottom of the insulation body 10. The retaining portion 110 in conjunction with the locking portion 1000 of the hole 100 secures the conductor terminal 11 in place while the contact portion 111 protrudes from the top to contact another abutted electronic device (not illustrated).

The circuit board 2 applying the soldering method of the present invention includes a board 20 and multiple blind holes 21, a soldering portion 3 disposed, and a tin paste 4 (or any other type of solder) in each blind hole 21. Upon soldering, the pin-shaped soldering portion 112 of the conductor terminal 11 is inserted into the blind hole 21 and soldered to the soldering portion 3 by heating up the tin paste 4. In the heating process, the electricity connector 1 is deformed due to the heat and the relative location of the electricity connector 1 to the circuit board 2 is biased. Therefore, when a void is created between the soldering portion 3 and the pin-shaped soldering portion 112 of the conductor terminal 11, the tin paste 4 immediately fills up the void to always maintain normal conduction between the circuit board 2 and the electricity connector 1 thus to realize the firm connection of electricity between the electricity connector 1 and the circuit board 2 when the tin paste 4 is cured.

Now referring to FIG. 5 for a second preferred embodiment of the soldering method of the present invention, the second preferred embodiment differs from the first one in that in the second preferred embodiment the tin paste 4 is placed first on the top of each blind hole 21 of the circuit board 2 and the soldering portion 112 of the conductor terminal 11 is inserted into the tin paste 4. When heated and molt, the tin paste 4 flows into the blind hole 21 to connect the circuit board 2 and the conductor terminal 11. Accordingly, normal conduction between the circuit board and the electricity connector is maintained when the electricity connector is deformed.

Alternatively, the same soldering result is realized by providing a soldering portion to the perimeter of the blind hole and/or at its bottom.

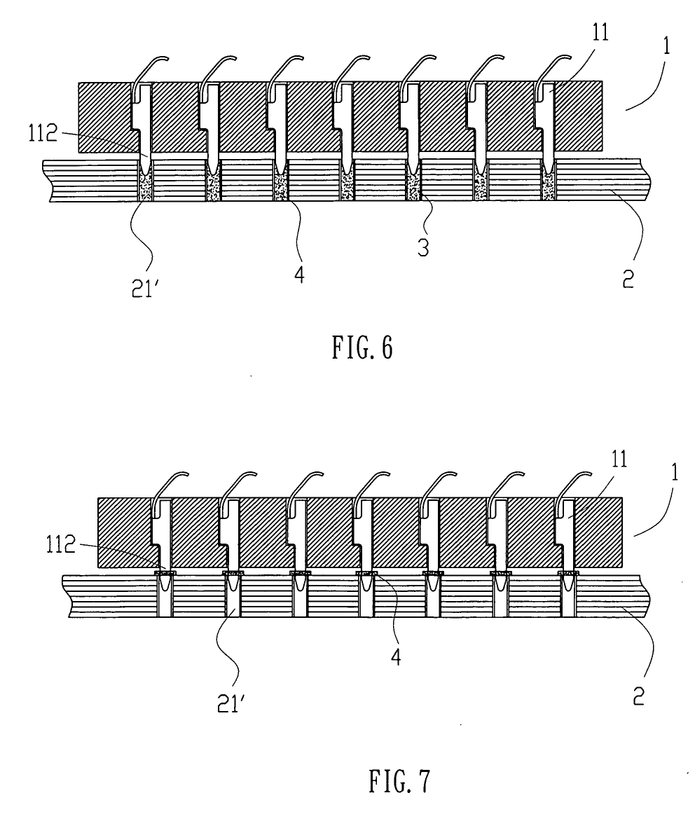

As illustrated in FIG. 6, a third preferred embodiment of the present invention has multiple through holes 21′ disposed on the circuit board 2; the soldering portion 3 disposed to the perimeter of the through hole 21′; the tin paste 4 placed in the through hole 21′; and the pin-shaped soldering portion 112 of the conductor terminal 11 is inserted into the through hole 21′ to be soldered to the soldering portion 3 by heating to melt the tin paste 4. Accordingly, normal conduction between the circuit board 2 and the electricity connector 1 is maintained when the electricity connector is deformed.

A soldering method of a fourth preferred embodiment of the present invention as illustrated in FIG. 7 differs from the third one in that the tin paste 4 is first place on top of the through hole 21′ of the circuit board 2 and the pin-shaped soldering portion 112 of the terminal 11. The tin paste 4 is heated to melt and flow into the through hole 21′ to solder both of the circuit board 2 and the conductor terminal 11. Accordingly, normal conduction between the circuit board 2 and the electricity connector 1 is maintained when the electricity connector is deformed.

What is claimed is:

1. A soldering method to solder two electronic devices to each other; one electronic device being disposed with multiple pin-shaped soldering ends; multiple soldering holes being disposed on another electronic device; solder being disposed in each hole; and the pin-shaped soldering end being inserted into the hole and soldered to the soldering portion by heating to melt the tin paste.

2. The soldering method of claim 1, wherein each hole on the electronic device relates to a blind hole.

3. The soldering method of claim 2, wherein, the soldering portion is located at the bottom of the blind hole.

4. The soldering method of claim 1, wherein each hole on the electronic device relates to a through hole.

5. The soldering method of claim 1, the soldering portion is located at the perimeter to the hole.

6. A circuit board is provided with multiple holes with each hole containing a soldering portion and a solder in relation to each hole.

7. The circuit board of claim 6, wherein each hole on the circuit board relates to a blind hole.

8. The circuit board of claim 7, wherein, the soldering portion is located at the bottom of the blind hole.

9. The circuit board of claim 6, wherein each hole on the circuit board relates to a through hole.

10. The circuit board of claim 6, the soldering portion is located at the perimeter to the hole.
